(19) United States
(12) Patent Application Publication
(10) Pub. No.: US 2009/0098833 A1
(43) Pub. Date: Apr. 16, 2009

(54) OPTICAL MODULE

(76) Inventors: Takashi Tokairin, Tokyo (JP); Tadashi Maeda, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 12/224,780

(22) PCT Filed: Feb. 15, 2007
(86) PCT No.: PCT/JP2007/052742

§ 371 Date: Sep. 5, 2008

(30) Foreign Application Priority Data
Mar. 7, 2006 (JP) 2006-061505
Sep. 27, 2006 (JP) 2006-262548

(51) Int. Cl. H04B 1/40

(52) U.S. Cl. 455/76

(57) ABSTRACT

A first frequency generator outputs a signal at first frequency f₁ which satisfies a relationship of f₁>f₀ with desired frequency f₀. A second frequency generator outputs a signal at second frequency f₂ which satisfies a relationship of f₂>f₀ with desired frequency f₀. A frequency discriminator frequency combines the signal generated from the first frequency generator with the signal generated from the second frequency generator to generate a signal which contains a component at desired frequency f₀. The frequency discriminator further passes therethrough only a frequency region lower than a predetermined threshold frequency of the generated signal.

### TECHNICAL FIELD

The present invention relates to a frequency synthesizer, and more particularly, to a frequency synthesizer for generating a plurality of signals at desired frequencies.

### BACKGROUND ART

As wireless units become increasingly integrated, a wireless device that use a single chip wireless communications IC (integrated circuit) to support a plurality of frequency bands of a wireless communication system has come into practical use. For example, M. Zargari “A Single-Chip Dual-Band Tri-Mode CMOS Transceiver for IEEE 802.11a/b/g Wireless LAN,” IEEE JSSC, Vol. 39, December 2004, pp. 2239-2249 discloses a configuration which can support two frequency bands, a 2.4-GHz band and a 5-GHz band defined in Wireless LAN (Local Area Network) Standards (IEEE802.11a/b/g). Also, R. Magoon, et al, “A Single-Chip Quad-Band (850/900/1800/1900 MHz) Direct Conversion GSM/GPRS RF Transceiver with Integrated VCOs and Fractional-N Synthesizer,” IEEE JSSC, vol. 37, December 2002, pp. 1710-1720 discloses a configuration which can support four bands, a 850-MHz band, a 900-MHz band, a 1800-MHz band, and a 1900-MHz band defined in the GSM (Global System for Mobile Communications) scheme.

It is thought that in the future, requests will be made for implementation of a so-called multi-band wireless device which not only handles a plurality of frequency bands in the same wireless communications system such as those, but also handles different frequency bands in a plurality of wireless communications system with a single wireless communications terminal (see Y. Neuvo, “Cellular Phones as Embedded Systems,” ISSCC 2004 Digest of Technical Papers, pp. 32-37, February 2004).

In signal processing in a general wireless device, the frequency of a signal of interest is converted by multiplying a local signal generated by a frequency synthesizer by the signal of interest in each of a transmission side and a reception side. As a general signal processing method, there is a method of converting a frequency in accordance with a direct conversion scheme. In the direct conversion scheme, a frequency conversion is performed once in signal processing on a transmission side or on a reception side.

Giving this direct conversion scheme as an example, signal processing is performed in the following manner.

On the reception side, a quadrature demodulator multiplies a received signal by a pair of reception local signals which are generated by a frequency synthesizer and which have phases different by π/2 from each other. Since the reception local signals are set at the same frequency as the reception signal, a desired signal is converted to an I-channel and a Q-channel baseband signal having a central frequency at 0 Hz through this multiplication.

On the transmission side, an I-channel and a Q-channel baseband transmission signal are applied to a quadrature modulator. The quadrature modulator multiplies the baseband transmission signals by a pair of transmission local signals generated by a frequency synthesizer and which have phases different by π/2 from each other. Since the transmission local signals are set at the same frequency as the transmission signals, output signals of the quadrature modulator are frequency converted to a transmission frequency.

Not limited to the direct conversion scheme herein illustrated, a frequency synthesizer used in a multi-band wireless device is required to generate local signals in a variety of frequency bands corresponding to a plurality of different wireless communications systems.

As a means for implementing the generation of desired frequencies over a wide band, a method is contemplated for using two frequency synthesizers, one of which generates an output which undergoes processing such as frequency division and the like, and then is multiplied by an output of the other synthesizer by a mixer to generate local signals which correspond to a plurality of frequency bands.

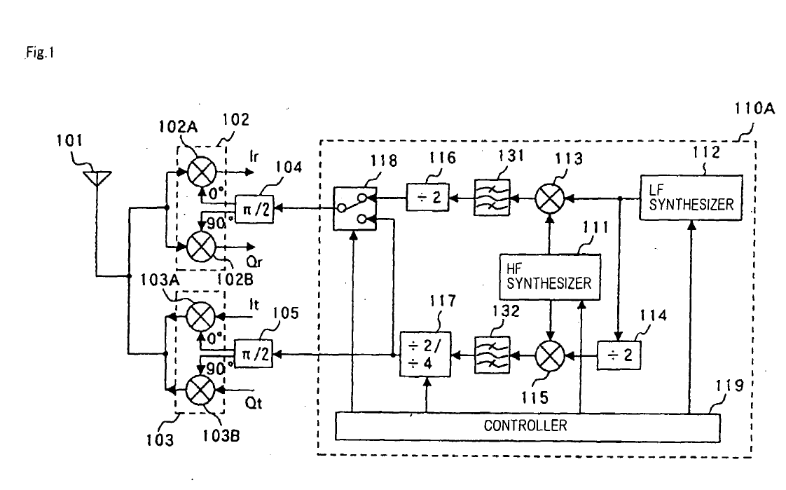

FIG. 1 is a block diagram showing the configuration of a multi-band wireless device. FIG. 1 shows the configuration disclosed in JP-2002-64397-A (pages 5-7, FIG. 5). Referring to FIG. 1, the multi-band wireless device described in JP-2002-64397-A comprises HF synthesizer 111 and LF synthesizer 112 as unit synthesizers. HF synthesizer 111 generates a first reference frequency signal which has a variable frequency in a high frequency band. LF synthesizer 112 generates a second frequency signal fixed at a frequency in a low frequency band. Then, this multi-band wireless device controls an operation including frequency division and multiplication using mixers 113, 115 and frequency dividers 114, 116, 117 as shown from controller 119.

By controlling this operation as appropriate, the multi-band wireless device generates transmission/reception local frequencies which are used by four wireless communications systems, GSM which uses a 900-MHz band, DSC (digital cellular system) in a 1800-MHz band, PCS (personal communication services) which uses a 1900-MHz band, and UTMS (universal mobile telecommunications system) which uses a 2-GHz band.

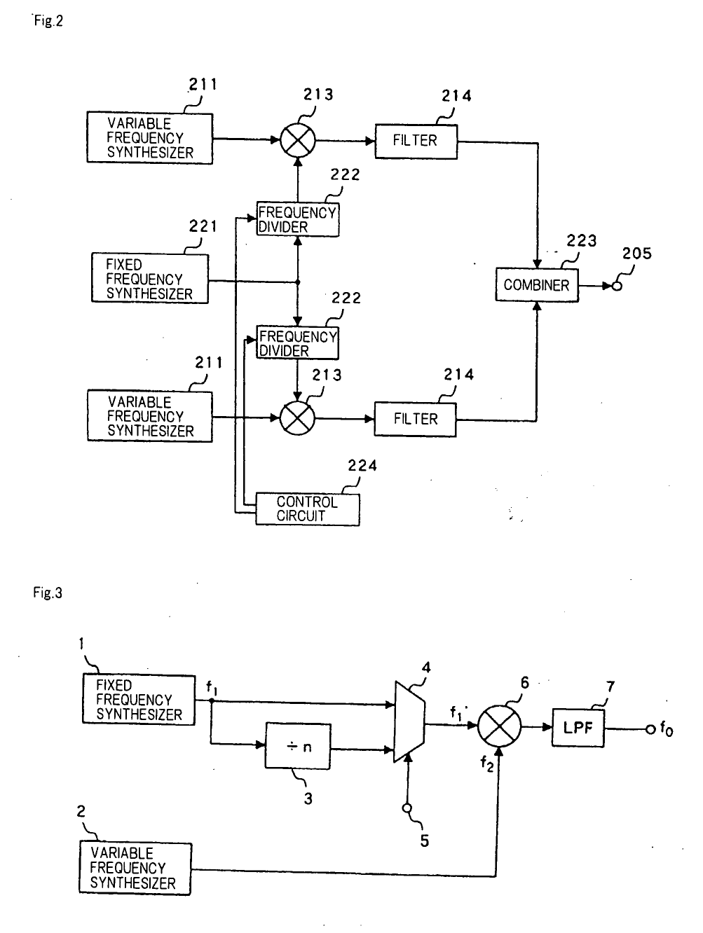

FIG. 2 is a block diagram showing the configuration of another frequency synthesizer. FIG. 2 shows the configuration disclosed in JP-6-120822-A (pages 2-3, FIG. 1). Referring to FIG. 2, the conventional frequency synthesizer comprises fixed frequency transmission circuit 221, two variable frequency synthesizers 211, two frequency dividers 222, and two mixers 213. Fixed frequency transmission circuit 221 outputs a signal at a fixed frequency which is twice the required frequency. Frequency divider 222 divides the frequency of the output of fixed frequency oscillator circuit 221 by a factor of two. Variable frequency synthesizer 211 is a PLL-based frequency synthesizer of the variable frequency type. Mixer 213 is configured to multiply the output of frequency divider 222 by the output of variable frequency synthesizer 211. A signal combined by mixer circuit 213 serves as a desired local frequency.

In this event, two frequency dividers 222 are controlled by control circuit 224, and one of a divide-by-two operation or an operation stop is selected therefor. Desired frequencies can be switched by controlling the operation of frequency divider 222.

### DISCLOSURE OF THE INVENTION

However, these frequency synthesizers disclosed in JP-2002-64397-A and JP-6-120822-A have several problems.

The mixer also generates a signal at an image frequency which is an unnecessary component, other than local signals at desired frequencies. For removing an image frequency signal with a filter provided at a stage subsequent to the mixer, the filter is required to exhibit frequency characteristics which pass local signals at desired frequencies through the filter and block the image frequency signal.

While there is a mixer (image rejection mixer) which comprises a function of removing an image frequency signal, its image suppression ratio is finite so that the image frequency signal cannot be completely removed. Thus, even if the image rejection mixer is used in the circuits described in JP-2002-64397-A and JP-6-120822-A, a filter is still required to be disposed at a stage subsequent thereto.

Also, when one of the signals that are applied to the mixer is at a relatively low frequency, the desired frequencies are close to an image frequency. For this reason, the filter is required to exhibit narrow-band and abrupt frequency characteristics.

Also, in the frequency synthesizer described above, since the desired frequency is variable to cause the image frequency to change as well, it needs to use a plurality of filters which are switched from one to another, or to use a filter which is capable of modifying the frequency characteristics.

It is difficult for a filter which exhibits fixed frequency characteristics to allow local signals at desired frequencies of a frequency synthesizer corresponding to such a plurality of frequency bands to pass therethrough and to remove an image frequency signal.

It is therefore necessary to switch a plurality of filters having different central frequencies or cut-off frequencies in line with frequency bands, or make the filter characteristics variable. However, in doing so, the circuit becomes more complicated and larger in scale.

On the other hand, if a filter is made to pass desired frequencies over an entire range in which they can vary, an image frequency signal will occur in a desired frequency band as unnecessary spurious.

Also, when a combined signal is frequency divided and used as in the circuit described in JP-2002-64397-A, a frequency variable range is narrowed due to the frequency division, causing impediments to a wider band.

It is an object of the present invention to provide a frequency synthesizer which is capable of generating a desired frequency in a small-scale and simple circuit configuration.

To achieve the above object, a frequency synthesizer of the present invention is a frequency synthesizer for generating a signal at desired frequency f₀, and comprises a first frequency generator, a second frequency generator, and a frequency discriminator.

The first frequency generator outputs a signal at first frequency f₁ which satisfies a relationship of f₁>f₀ with desired frequency f₀. The second frequency generator outputs a signal at second frequency f₂ which satisfies a relationship of f₂>f₀ with desired frequency f₀. The frequency discriminator frequency combines the signal generated from the first frequency generator with the signal generated from the second frequency generator to generate a signal which contains a component at desired frequency f₀, and passes therethrough only a frequency region lower than a predetermined threshold frequency of the generated signal.

According to the present invention, since frequency f₁, frequency f₂, and desired frequency f₀ are in relationships of f₁>f₀ and f₂>f₀, f₀<f_{IM} is always established between desired frequency f₀=|f₁−f₂| and image frequency f_{IM}=f₁+f₂, so that a signal at the image frequency can be simply removed by an element which has fixed low-pass frequency characteristics. This can result in the construction of a frequency synthesizer which is capable of generating desired frequency f₀ in a small scale and simple configuration.

### BRIEF DESCRIPTION OF THE DRAWINGS

[FIG. 1]

A block diagram showing the configuration of a multi-band wireless device.

[FIG. 2]

A block diagram showing the configuration of another frequency synthesizer.

[FIG. 3]

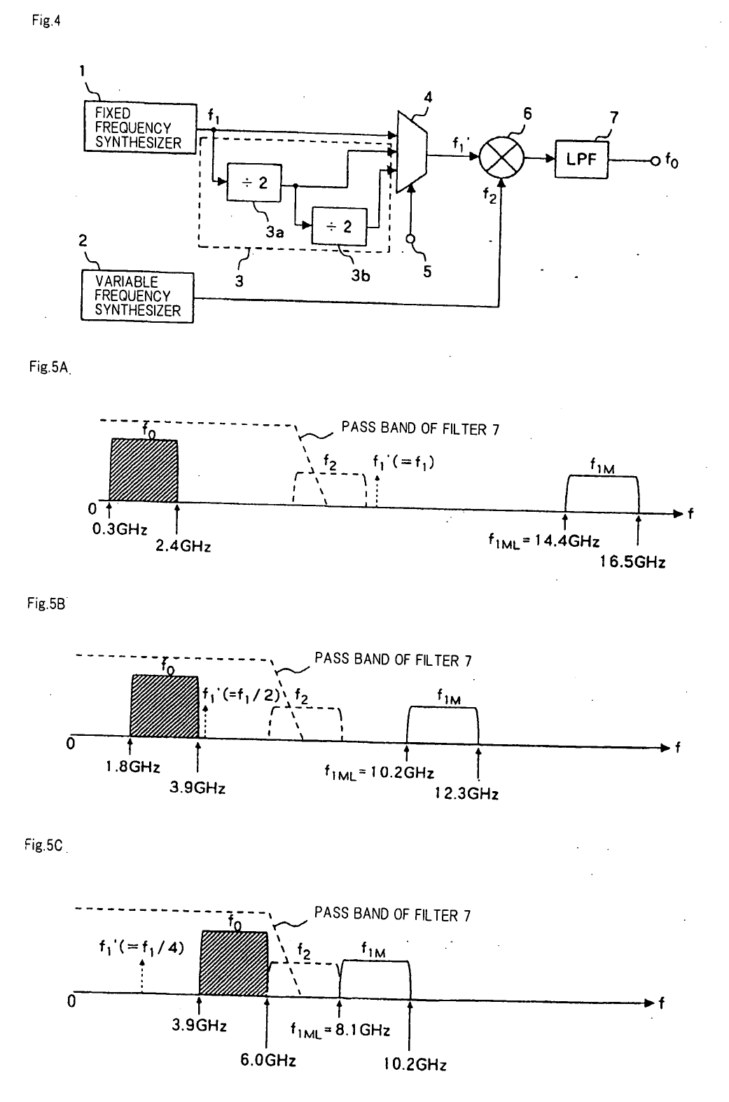

A block diagram showing the configuration of a multi-band frequency synthesizer of this embodiment.

[FIG. 4]

A block diagram showing the configuration of a multi-band frequency synthesizer of the First Example.

[FIG. 5A]

A diagram showing a frequency distribution when selector 4 selects a signal at f_{1′}=8.4 GHz from frequency synthesizer 1 in the First Example.

[FIG. 5B]

A diagram showing a frequency distribution when selector 4 selects a signal at f_{1′}=4.2 GHz from frequency synthesizer 1 in the First Example.

[FIG. 5C]

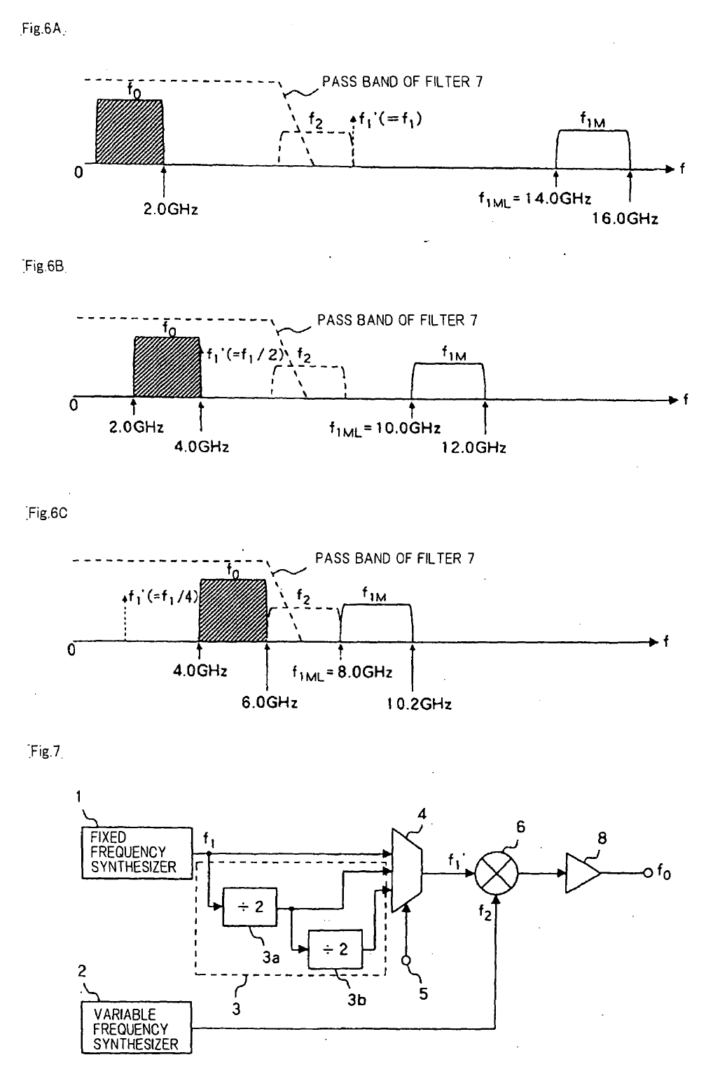

A diagram showing a frequency distribution when selector 4 selects a signal at f_{1′}=2.1 GHz from frequency synthesizer 1 in the First Example.

[FIG. 6A]

A diagram showing a frequency distribution when selector 4 selects a signal at f_{1′}=8.0 GHz from frequency synthesizer 1 in the First Example.

[FIG. 6B]

A diagram showing a frequency distribution when selector 4 selects a signal at f_{1′}=4.0 GHz from frequency synthesizer 1 in the First Example.

[FIG. 6C]

A diagram showing a frequency distribution when selector 4 selects a signal at f_{1′}=2.0 GHz from frequency synthesizer 1 in the First Example.

[FIG. 7]

A block diagram showing the configuration of a multi-band frequency synthesizer of the Second Example.

[FIG. 8]

A block diagram showing the configuration of a multi-band frequency synthesizer of the Third Example.

[FIG. 9]

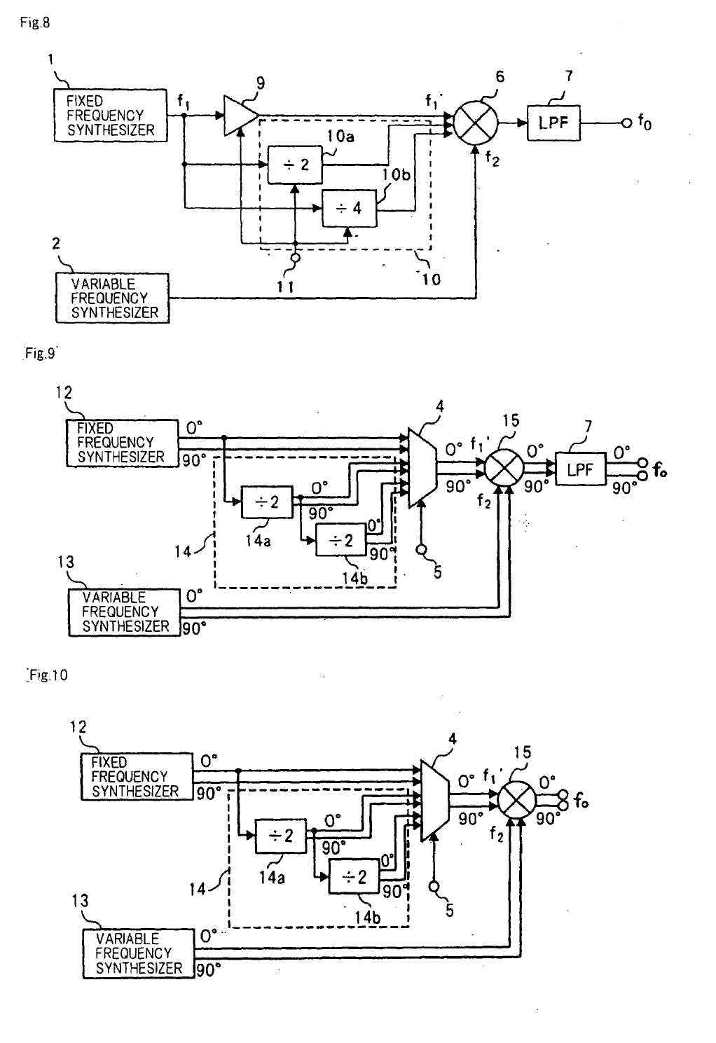

A block diagram showing the configuration of a multi-band frequency synthesizer of the Fourth Example.

[FIG. 10]

A block diagram showing the configuration of a multi-band frequency synthesizer of the Fifth Example.

[FIG. 11]

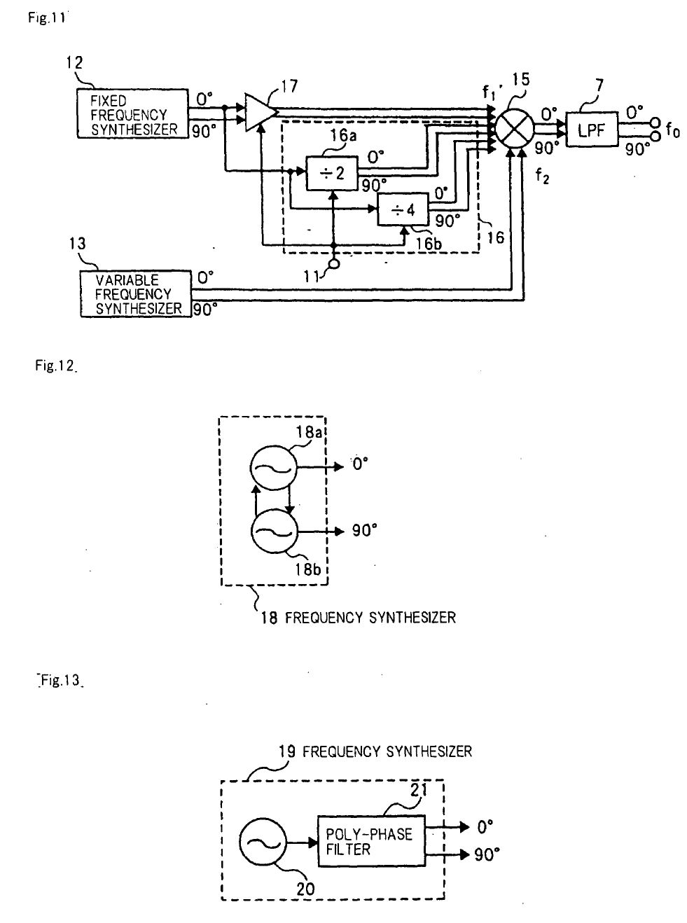

A block diagram showing the configuration of a multi-band frequency synthesizer of the Sixth Example.

[FIG. 12]

A block diagram showing an exemplary frequency synthesizer which is used as fixed frequency synthesizer 12 and variable frequency synthesizer 13 in FIGS. 9-11.

[FIG. 13]

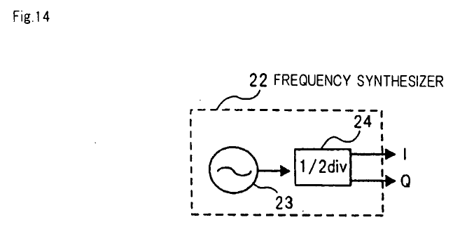

A block diagram showing another exemplary frequency synthesizer which is used as fixed frequency synthesizer 12 and variable frequency synthesizer 13 in FIGS. 9-11.

[FIG. 14]

A block diagram showing a further exemplary frequency synthesizer which is used as fixed frequency synthesizer 12 and variable frequency synthesizer 13 in FIGS. 9-11.

### BEST MODE FOR CARRYING OUT THE INVENTION

Embodiments for carrying out the present invention will be described in detail with reference to the drawings.

FIG. 3 is a block diagram showing the configuration of a multi-band frequency synthesizer of this embodiment. Referring to FIG. 3, the multi-band frequency synthesizer of this embodiment comprises fixed frequency synthesizer 1, variable frequency synthesizer 2, frequency divider 3, selector 4, mixer 6, and low pass filter 7.

Fixed frequency synthesizer 1 generates a signal at fixed frequency f₁. Variable frequency synthesizer 2 generates a signal at variable frequency f₂. Fixed frequency synthesizer 1 and variable frequency synthesizer 2 are configured, for example, using a PLL (phase locked loop). Frequency divider 3 divides the signal at fixed frequency f₁ generated by frequency synthesizer 1 at frequency division ratio n to output a signal at frequency f₁/n.

Here, frequency f₁ and frequency f₂ are in a relationship of f₁>f₀ and f₂>f₀ with respect to desired frequency f₀. Also, frequency f₁/n of the output signal of frequency divider 3 and frequency variable width Δf₂ of variable frequency f₂ are in a relationship of f₁/n>A f₂/2.

Local signals for use by a multi-band wireless device are generated by performing signal processing on the signals generated by these frequency synthesizers in the following manner.

Selector 4 receives the output signal of frequency synthesizer 1 and the output signal of frequency divider 3, and selects and outputs one of signals having frequencies f₁ and f₁/n in accordance with a control signal from control terminal 5. Assume that this selector 4 outputs a signal at frequency f₁.

The output signal at frequency f_{1′} output from selector 4 and the signal at variable frequency f₂ generated by frequency synthesizer 2 are applied to mixer 6.

Mixer 6 multiplies the two input signals to generate a differential frequency signal which is local signal f₀ at desired frequency f₀=|f_{1′}−f₂|. Simultaneously with this, mixer 6 generates a sum frequency signal of the two input signals as an image frequency signal. This image frequency signal is filtered by low pass filter 7 connected at a stage subsequent to the mixer. In this regard, mixer 6 may be an image rejection mixer which comprises a function of removing the image frequency signal.

From the relationships of f₁>f₀ and f₂>f₀ as well as f₁/n>Δf₂/2, frequency f_{IM} of the image signal generated by mixer 6 is always higher than desired frequency f₀. For this reason, the image frequency signal can be removed by single LPF 7 which exhibits fixed frequency characteristics without the need for employing a variable filter for LPF 7 or switching a plurality of filters.

In the following, a detailed description will be given.

First, when selector 4 selects the signal at fixed frequency f₁ from fixed frequency synthesizer 1, i.e., when f_{1′}=f₁, desired frequency f₀ is f₀=|f₁−f₂|, and frequency f_{IM} of the image signal is f_{IM}=f₁+f₂, so that f₀<f_{IM} is established at all times. Accordingly, the image signal can be simply removed by a low pass filter.

Next, when selector 4 selects the signal at frequency f₁/n from frequency divider 3, i.e., when f_{1′}=f₁/n, desired frequency f₀ is f₀=f₂−f₁/n. Variable frequency f₂ in turn is represented by f₂=f₂L+Δf₂, using lower limit f_{2L} of a variable range and frequency variable width Δf₂. Thus, lower limit f_{IML} of the image frequency generated by mixer 6 is f_{IML}=f_{2L}+f₁/n.

In this event, when f₁/n>Δf₂/2, i.e., when frequency f₁/n after the frequency division is higher than one-half of frequency variable range □f₂ of f₂, f_{IML} satisfies the relationship of the following Equation (1):

### [Equation 1]

f_{IML}=f_{2L}+f₁/n>f_{2L}+Δf₂/2 (1)

Also, for desired frequency f₀=f₂−f₁/n, the relationship of Equation (2) is satisfied.

### [Equation 2]

f₀=f₂−f₁/n<f₂−Δf₂/2 (2)

Further, since variable frequency f₂ is represented by f₂=f_{2L}+Δf₂, Equation (2) can be represented as Equation (3):

### [Equation 3]

f₀=f₂−f₁/n<f_{2L}+Δf₂/2 (3)

Accordingly, since f₀<f_{2L}+Δf₂/2<f_{IML} from Equations (1), (3), lower limit f_{IML} of the image frequency is higher than desired signal f₀, and the relationship of f₀<f_{IM} is established between the desired signal and the image signal.

Consequently, the image signal can be simply removed by setting LPF 7 such that desired frequency f₀ falls within a pass band.

Conversely, when f₁/n<Δf₂/2, desired frequency f₀ and lower limit f_{IML} of the image frequency are given by the following Equations (4) and (5), respectively:

### [Equation 4]

f₀=f₂−f₁/n>f₂−Δf₂/2=f_{2L}+Δf₂/2 (4)

### [Equation 5]

f_{IML}=f_{2L}+f₁/n<f_{2L}+Δf₂/2 (5)

Thus, in this event, f₀>f_{IML} stands, and f₀<f_{IM} is not established, so that it is difficult to remove the image frequency signal by the low pass filter.

On the other hand, taking into consideration frequency variable width of a frequency synthesizer, desired frequency f₀, when selector 4 selects the signal at fixed frequency f₁ from fixed frequency synthesizer 1, is represented as in Equation 6 using variable range Δf₂ of variable frequency f₂. Also, desired frequency f₀, when selector 4 selects the signal at frequency f₁/n from frequency divider 3, is represented as in Equation (7) using variable width Δf₂ of variable frequency f₂.

### [Equation 6]

f₀=|f₁−f₂|=|f₁−(f_{2L}+Δf₂)| (6)

### [Equation 7]

f₀=f₂−f₁/n=f_{2L}+Δf₂−f₁/n (7)

It can therefore be understood that variable width Δf₂ of the frequency of variable frequency synthesizer 2 fits, as it is, in a variable range for the desired frequency of the entire multi-band frequency synthesizer of this embodiment. In the technique described in JP-2002-64397-A, the variable width of a frequency is narrowed due to frequency division to cause impediments to designing a frequency synthesizer that provides a wider band. This embodiment solves this problem.

According to this embodiment as described above, since fixed frequency f₁, variable frequency f₂, and desired frequency f₀ are in a relationship of f₁>f₀ and f₂>f₀, desired frequency f₀=|f₁−f₂| and image frequency f_{IM}=f₁+f₂ are always in a relationship of f₀<f_{IM} when selector 4 selects the signal at frequency f₁. Thus, the image frequency signal can be simply removed by LPF 7, which has fixed low-pass type frequency characteristics, without providing a filter capable of modifying the characteristics or providing a plurality of switchable filters at a stage subsequent to mixer 6. As a result, a frequency synthesizer capable of generating a desired frequency can be constructed in a small scale and simple configuration.

Also, according to this embodiment, since frequency f₁/n of the output signal of frequency divider 3 and variable width Δf₂ of variable frequency f₂ are in a relationship of f₁/n>Δf₂/2, the image frequency signal can be simply removed by LPF 7, which has fixed low-pass type frequency characteristics, even when selector 4 selects the output of frequency divider 3. As a result, it is possible to provide a frequency synthesizer capable of generating a desired frequency over a wide band without causing an increase in circuit scale or higher complexity.

Also, according to this embodiment, since frequency variable width Δf₂ of variable frequency synthesizer 2 fits, as it is, in the variable range of the desired frequency of the multi-band frequency synthesizer, the frequency variable width will not be narrowed due to frequency division to cause impediments to a wider band of the multi-band frequency synthesizer.

Descriptions will be given of more specific Examples of this embodiment.

### FIRST EXAMPLE

FIG. 4 is a block diagram showing the configuration of a multi-band frequency synthesizer of the First Example. Referring to FIG. 4, the multi-band frequency synthesizer of the First Example comprises fixed frequency synthesizer 1, variable frequency synthesizer 2, frequency divider 3, selector 4, mixer 6, and low pass filter 7. Frequency divider 3 includes two frequency dividers 3a, 3b.

This is a specific configuration of frequency divider 3 of the multi-band frequency synthesizer shown in FIG. 3. The remaining fixed frequency synthesizer 1, variable frequency synthesizer 2, selector 4, mixer 6, and low pass filter 7 are the same as those described above.

Frequency dividers 3a, 3b, which make up frequency divider 3, both have a division ratio of “2.” Frequency divider 3 is applied with a signal at fixed frequency f₁ generated by fixed frequency synthesizer 1. Frequency divider 3a divides the signal at fixed frequency f₁ from fixed frequency synthesizer 1 to generate a signal at frequency f₁/2. Frequency divider 3b divides the signal from frequency divider 3a to generate a signal at frequency f₁/4. Signals from frequency dividers 3a, 3b are applied to selector 4.

Selector 4 selects one of the signals at frequencies f₁, f₁/2, f₁/4 in accordance with a control signal from control terminal 5 for delivery to LPF 7. Assume that selector 4 outputs a signal at frequency f_{1′}.

Next, a specific description will be given of the operation of the multi-band frequency synthesizer of the First Example. FIGS. 5A-5C are diagrams showing frequency distributions for describing exemplary operations of the multi-band frequency synthesizer of the First Example.

Assume herein that fixed frequency f₁ generated by frequency synthesizer 1 is 8.4 GHz, and variable frequency f₂ generated by frequency synthesizer 2 is 6.0-8.1 GHz.

The output of frequency synthesizer 1 is frequency divided by frequency dividers 3a, 3b, respectively, to one-half frequency, and selector 4 is applied with signals at 8.4 GHz, 4.2 GHz, and 2.1 GHz. Selector 4 selects one of these signals.

In this event, desired frequency f₀ output from mixer 6 of this Example is 0.3-6.0 GHz, and the aforementioned relationships f₁>f₀ and f₂>f₀ are established among frequencies f₁ and f₂ and desired frequency f₀.

Also, a frequency division ratio “n” of frequency divider 3 is n=4 at maximum in this Example, and variable frequency f₂ generated by frequency synthesizer 2 has variable width Δf₂=2.1 GHz, so that the aforementioned f₁/n>Δf₂/2 is established.

Also, the cut-off frequency of low-pass filter 7 is herein set to 6.0 GHz.

In the following, the operation of the First Example will be described using specific examples of values. Specific operations will be described for each selection in selector 4.

FIG. 5A is a diagram showing a frequency distribution when selector 4 selects a signal at f_{1′}=8.4 GHz from frequency synthesizer 1. The input/output of mixer 6 are as shown in FIG. 5A. Mixer 6 outputs a desired signal at a differential frequency (desired frequency) between the signal at f_{1′}=8.4 GHz from fixed frequency synthesizer 1 and the signal at frequency f₂ from frequency synthesizer 2. The desired frequency f₀ is 0.3-2.4 GHz. Image frequency f_{IM} in turn is 14.4-16.5 GHz which is a sum frequency of the two input signals. This sum frequency is removed because it is out of the pass band of low pass filter 7.

FIG. 5B is a diagram showing a frequency distribution when selector 4 selects the signal at f_{1′}=4.2 GHz from frequency synthesizer 1. The input/output of mixer 6 are as shown in FIG. 5B. Mixer 6 outputs a desired signal at a differential frequency (desired frequency) between the signal at f_{1′}=4.2 GHz from fixed frequency synthesizer 1 and the signal at frequency f₂ from frequency synthesizer 2. The desired frequency f₀ is 1.8-3.9 GHz. Image frequency f_{IM} in turn is 10.2-12.3 GHz which is a sum frequency of the two input signals. This sum frequency is removed because it is out of the pass band of low pass filter 7.

FIG. 5C is a diagram showing a frequency distribution when selector 4 selects the signal at f_{1′}=2.1 GHz from frequency synthesizer 1. The input/output of mixer 6 are as shown in FIG. 5C. Mixer 6 outputs a desired signal at a differential frequency (desired frequency) between the signal at f_{1′}=2.1 GHz from fixed frequency synthesizer 1 and the signal at frequency f₂ from frequency synthesizer 2. The desired frequency f₀ is 3.9-6.0 GHz. Image frequency f_{IM} in turn is 8.1-10.2 GHz which is a sum frequency of the two input signals. This sum frequency is removed because it is out of the pass band of low pass filter 7.

According to this example, it is possible to realize a multi-band frequency synthesizer of 0.3-6.0 GHz in a small scale and simple configuration.

In the following, the operation of the First Example will be described using other examples of values. A specific operation will be described for each selection in selector 4. FIGS. 6A-6C are diagrams showing frequency distributions for describing other exemplary operations of the multi-band frequency synthesizer of the First Example. Assume herein that the upper limit of desired frequency f₀ is 6.0 GHz.

Assume in this example that fixed frequency f₁ generated by frequency synthesizer 1 is 8.0 GHz which is 4/3 times as high as the upper limit of desired frequency f₀. Assume that variable frequency f₂ generated by frequency synthesizer 2 has an upper limit of 8.0 GHz equal to fixed frequency f₁ and a lower limit of 6.0 GHz that is ¾ times as high as fixed frequency f₁.

FIG. 6A is a diagram showing a frequency distribution when selector 4 selects the signal at f_{1′}=8.0 GHz from frequency synthesizer 1. The input/output of mixer 6 are as shown in FIG. 6A. Mixer 6 outputs a desired signal at a differential frequency (desired frequency) between the signal at f_{1′}=8.0 GHz from fixed frequency synthesizer 1 and the signal at frequency f₂ from frequency synthesizer 2. The desired frequency f₀ is 0-2.0 GHz. Image frequency f_{IM} in turn is 14.0-16.0 GHz which is a sum frequency of the two input signals. Since this sum frequency is out of the pass band of low pass filter 7, it is removed.

FIG. 6B is a diagram showing a frequency distribution when selector 4 selects the signal at f_{1′}=4.0 GHz from frequency synthesizer 1. The input/output of mixer 6 are as shown in FIG. 6B. Mixer 6 outputs a desired signal at a differential frequency (desired frequency) between the signal at f_{1′}=4.0 GHz from fixed frequency synthesizer 1 and the signal at frequency f₂ from frequency synthesizer 2. The desired frequency f₀ is 2.0-4.0 GHz. Image frequency f_{IM} in turn is 10.0-12.0 GHz which is a sum frequency of the two input signals. Since this sum frequency is out of the pass band of low pass filter 7, it is removed.

FIG. 6C is a diagram showing a frequency distribution when selector 4 selects the signal at f_{1′}=2.0 GHz from frequency synthesizer 1. The input/output of mixer 6 are as shown in FIG. 6C. Mixer 6 outputs a desired signal at a differential frequency (desired frequency) between the signal at f_{1′}=2.0 GHz from fixed frequency synthesizer 1 and the signal at frequency f₂ from frequency synthesizer 2. The desired frequency f₀ is 4.0-6.0 GHz. Image frequency f_{IM} in turn is 8.0-10.0 GHz which is a sum frequency of the two input signals. Since this sum frequency is out of the pass band of low pass filter 7, it is removed.

When the frequency division ratio of frequency divider 3 is four at maximum, as in this example, the aforementioned relationships f₁>f₀ and f₂>f₀ as well as f₁/n>Δf₂/2 are established if fixed frequency f₁ is set to the frequency that is 4/3 times as high as the upper limit of desired frequency f₀, the upper limit of variable frequency f₂ is set equal to fixed frequency f₁, and the lower limit of variable frequency f₂ is set to ¾ times as high as fixed frequency f₁. According to this example, it is possible to realize a multi-band frequency synthesizer of 0-6.0 GHz in a small scale and simple configuration.

It should be apparent that fixed frequency f₁, variable frequency f₂, and desired frequency f₀ in this example are not limited to the values shown herein, but can be applied to any desired frequency f₀ as long as fixed frequency f₁ is equal to or higher than 4/3 times as high as the upper limit of desired frequency f₀, and variable frequency f₂ is in a range of 3f₁/4 to f₁.

### SECOND EXAMPLE

FIG. 7 is a block diagram showing the configuration of a multi-band frequency synthesizer of Second Example. Referring to FIG. 7, the multi-band frequency synthesizer of Second Example comprises fixed frequency synthesizer 1, variable frequency synthesizer 2, frequency divider 3, selector 4, mixer 6, and amplifier 8. Frequency divider 3 includes two frequency dividers 3a, 3b. The multi-band frequency synthesizer of FIG. 7 is substantially the same as that shown in FIG. 4 in configuration. A difference lies in that low pass filter 7 is removed at the stage subsequent to mixer 6, and amplifier 8 is provided instead. Amplifier 8 has low-pass frequency characteristics.

In this Embodiment, from the fact that the image frequency can be removed by a fixed low-pass characteristic, the Second Example comprises the function of filter 7 by using a buffer amplifier connected between a synthesizer and a modulator or a demodulator, which is essential in a general wireless device. According to this configuration, the circuit of the multi-band frequency synthesizer can be further reduced in size.

### THIRD EXAMPLE

FIG. 8 is a block diagram showing the configuration of a multi-band frequency synthesizer of the Third Example. Referring to FIG. 8, the multi-band frequency synthesizer of the Third Example comprises fixed frequency synthesizer 1, variable frequency synthesizer 2, mixer 6, LPF 7, buffer amplifier 9, and frequency divider 10. Frequency divider 10 includes two frequency dividers 10a, 10b.

Frequency divider 10a has a frequency division ratio of “2,” while frequency divider 10b has a frequency division ratio of “4.” Frequency dividers 10a, 10b respectively divide a signal at fixed frequency f₁ from fixed frequency synthesizer 1.

Buffer amplifier 9 and frequency dividers 10a, 10b have outputs connected in parallel with mixer 6. Then, one of buffer amplifier 9 or frequency dividers 10a, 10b is selected by a control signal from control terminal 11. An element not selected stops the output, whereas only a selected element performs an output, so that an output signal of the element alone is applied to mixer 6.

By using this configuration, selector 4 can be omitted in the configuration of the First and the Second Examples, so that the circuit of the multi-band frequency synthesizer can be further reduced in size.

### FOURTH EXAMPLE

FIG. 9 is a block diagram showing the configuration of a multi-band frequency synthesizer of the Fourth Example. Referring to FIG. 9, multi-band frequency synthesizer of the Fourth Example comprises fixed frequency synthesizer 12, variable frequency synthesizer 13, frequency divider 14, selector 4, image rejection mixer 15, and LPF 7. Frequency divider 14 includes two frequency dividers 14a, 14b.

The multi-band synthesizer of FIG. 9 is substantially the same as that shown in FIG. 4 in configuration. A difference lies in that the multi-band synthesizer of FIG. 9 handles an I (in-phase: zero degree) and a Q (quadrature: 90 degrees) signal which are out of phase with each other by 90 degrees. Thus, fixed frequency synthesizer 12, variable frequency synthesizer 13, and frequency divider 14 all output I-signals and Q-signals.

Two frequency dividers 14a, 14b which make up frequency divider 14 comprise a function of outputting the I/Q signals, and therefore, frequency divider 14 may be applied with one of the I-signal or Q-signal. Here, frequency divider 14 is applied with the I-signal.

In this Example, image rejection mixer 15 multiplies a signal at fixed frequency f₁ by a signal at variable frequency f₂. Since image rejection mixer 15 has a function of removing an image frequency signal, the component of image frequency f_{IM} is suppressed to some extend at the output of image rejection mixer 15. Accordingly, the conditions required for the filter characteristics of LPF 7 disposed at a stage subsequent to image rejection mixer 15 are alleviated, as compared with an Example which does not employ the image rejection mixer.

Also, since the multi-band frequency synthesizer of this Example outputs the I/Q signals which are out of phase with each other by 90 degrees, it is suitable for wireless systems that have quadrature modulation schemes such as QPSK and QAM.

For reference, in FIG. 9, frequency divider 14a is applied with the I-signal from fixed frequency synthesizer 12, while frequency divider 14b is applied with the I-signal from frequency divider 14a, by way of example. However, one or both of frequency divider 14a and frequency divider 14b may be applied with the Q-signal.

Also, while LPF 7 is used in FIG. 9 as an example, an amplifier having low-pass frequency characteristics may be used instead of LPF 7 in a manner similar to the Second Example shown in FIG. 7.

### FIFTH EMBODIMENT

FIG. 10 is a block diagram showing the configuration of a multi-band frequency synthesizer of the Fifth Example. Referring to FIG. 10, the multi-band frequency synthesizer of the Fifth Example comprises fixed frequency synthesizer 12, variable frequency synthesizer 13, frequency divider 14, selector 4, and image rejection mixer 15. The multi-band synthesizer of FIG. 10 is substantially the same as that shown in FIG. 9 in configuration. A difference lies in that LPF 7 is omitted in this Example.

Since the image rejection mixer has a limited image suppression ratio, image rejection mixer 15 cannot completely remove the image signal. However, since image frequency f_{IM} is outside the desired band in this example as described above, LPF 7 can be omitted as the case may be like this Example.

According to the configuration of this Example, the circuit of the multi-band frequency synthesizer can further be reduced in size.

### SIXTH EMBODIMENT

FIG. 11 is a block diagram showing the configuration of a multi-band frequency synthesizer of Sixth Example. Referring to FIG. 11, the multi-band frequency synthesizer of Sixth Example comprises fixed frequency synthesizer 12, variable frequency synthesizer 13, image rejection mixer 15, frequency divider 16, buffer amplifier 17, and LPF 7. Frequency divider 16 includes two frequency dividers 16a, 16b.

The multi-band synthesizer of FIG. 11 is substantially the same as that shown in FIG. 8 in configuration. A difference lies in that the multi-band synthesizer of FIG. 11 handles an I (in-phase: zero degree) and Q (quadrature: 90 degrees) signal which are out of phase with each other by 90 degrees. Thus, fixed frequency synthesizer 12, variable frequency synthesizer 13, and frequency divider 16 all output I-signals and Q-signals.

Two frequency dividers 16a, 16b which make up frequency divider 16 comprise a function of outputting the I/Q signals, and therefore, frequency divider 16 may be applied with one of the I-signal and Q-signal.

Frequency divider 16a has a frequency division ratio of “2,” while frequency divider 16b has a frequency division ratio of “4.” Frequency dividers 16a, 16b respectively divide a signal at fixed frequency f₁ from fixed frequency synthesizer 12.

In this Example, buffer amplifier 17, frequency divider 16a, and frequency divider 16b are connected in parallel between fixed frequency synthesizer 12 and image rejection mixer 15. Then, buffer amplifier 17, frequency divider 16a, and frequency divider 16b are applied with a control signal from control terminal 11. One of buffer amplifier 17, frequency divider 16a, or frequency divider 16b is selected by the control signal. An element not selected stops the output, whereas only a selected element performs an output, so that an output signal of the element alone is applied to image rejection mixer 15.

In this Example, since image rejection mixer 15 multiplies a signal at fixed frequency f_{1′} by a signal at variable frequency f₂, the component of image frequency f_{IM} is suppressed to some extend at the output of image rejection mixer 15. Accordingly, the conditions required for the filter characteristics of LPF 7 disposed at a stage subsequent to image rejection mixer 15 are alleviated, as compared with an Example which does not employ the image rejection mixer.

Also, since the multi-band frequency synthesizer of this Example outputs the I/Q signals which are out of phase with each other by 90 degrees, it is suitable for wireless systems that have quadrature modulation schemes such as QPSK and QAM.

Also, according to this Example, selector 4 can be omitted in the configuration of the Fourth Example, so that the circuit of the multi-band frequency synthesizer can be further reduced in size.

For reference, in FIG. 11, frequency dividers 16a, 16b are applied with the I-signal from fixed frequency synthesizer 12. However, one or both of frequency divider 16a and frequency divider 16b may be applied with the Q-signal from fixed frequency synthesizer 12.

Also, while LPF 7 is used in FIG. 11 as an example, an amplifier having low-pass frequency characteristics may be used instead of LPF 7 in a manner similar to the Second Example shown in FIG. 7.

Also, LPF 7 may be omitted in this Example as well, as is the case with the Fifth Example. Since the image rejection mixer has a limited image suppression ratio, image rejection mixer 15 cannot completely remove the image signal. However, since image frequency f_{IM} is out of a desired band in this example as described above, LPF 7 can be omitted as the case may be like this Example. According to this configuration, the circuit of the multi-band frequency synthesizer can further be reduced in size.

As described above, multi-band frequency synthesizers which handle I/Q signals have been shown as Fourth—Sixth Examples. In these Examples, fixed frequency synthesizer 12 and variable frequency synthesizer 13 outputs I-signals and Q-signals. A description will be given below of specific exemplary configurations of such a frequency synthesizer which outputs an I-signal and a Q-signal.

### SEVENTH EXAMPLE

FIG. 12 is a block diagram showing an example of a frequency synthesizer which is used as fixed frequency synthesizer 12 or variable frequency synthesizer 13 of FIGS. 9-11. Referring to FIG. 12, frequency synthesizer 18 of this Example comprises oscillator 18a and oscillator 18b.

Oscillator 18a is an oscillator for generating an oscillating signal with the phase of zero degree. Oscillator 18b is an oscillator for generating an oscillating signal with the phase of 90 degrees. Then, the outputs of oscillator 18a and oscillator 18b are coupled with each other to match an oscillating frequency.

Since frequency synthesizer 18 of this Example generates two signals which are out of phase with each other by 90 degrees, it can be used as fixed frequency synthesizer 12 at frequency f₁ or variable frequency synthesizer 13 at frequency f₂ in the Fourth—Sixth Examples.

### EIGHTH EMBODIMENT

FIG. 13 is a block diagram showing another example of a frequency synthesizer which is used as fixed frequency synthesizer 12 or variable frequency synthesizer 13 of FIG. 9-11. Referring to FIG. 13, frequency synthesizer 19 of this Example comprises oscillator 20 and poly-phase filter 21.

Oscillator 20 generates an oscillating signal at a desired frequency. When frequency synthesizer 19 is used as fixed frequency synthesizer 12, a desired frequency is f₁. When frequency synthesizer 19 is used as variable frequency synthesizer 13, a desired frequency is f₂. The oscillating signal generated by oscillator 20 is applied to poly-phase filter 21.

Poly-phase filter 21 generates an oscillating signal which is out of phase by 90 degrees from the oscillating signal generated by oscillator 20, from this oscillating signal.

Since frequency synthesizer 19 of this Example generates two signals which are out of phase with each other by 90 degrees, it can be used as fixed frequency synthesizer 12 at frequency f₁ or variable frequency synthesizer 13 at frequency f₂ in the Fourth—Sixth Examples.

### NINTH EXAMPLE

FIG. 14 is a block diagram showing a further example of a frequency synthesizer which is used as fixed frequency synthesizer 12 or variable frequency synthesizer 13 of FIG. 9-11. Referring to FIG. 14, frequency synthesizer 22 of this Example comprises oscillator 23 and frequency divider 24.

Oscillator 23 generates an oscillating signal at a frequency twice as high as a desired frequency. When frequency synthesizer 22 is used as fixed frequency synthesizer 12, the oscillating frequency of oscillator 23 is 2×f₁. When frequency synthesizer 22 is used as variable frequency synthesizer 13, the oscillating frequency of oscillator 23 is 2×f₂. The oscillating signal generated by oscillator 23 is applied to frequency divider 24.

Frequency divider 24 has a frequency division ratio of “2.” Frequency divider 24 frequency divides the oscillating signal from oscillator 23 by one-half to generate two signals at a desired frequency, which are out of phase with each other by 90 degrees.

Since frequency synthesizer 22 of this Example generates two signals which are out of phase with each other by 90 degrees, it can be used as fixed frequency synthesizer 12 at frequency f₁ or variable frequency synthesizer 13 at frequency f₂ in the Fourth—Sixth Examples.

1. A frequency synthesizer for generating a signal at desired frequency f₀, comprising:
a first frequency generator for outputting a signal at first frequency f₁ which satisfies a relationship of f₁>f₀ with the desired frequency f₀;
a first frequency divider for dividing the signal at the first frequency f₁ generated by said first frequency generator at frequency division ratio n;
a second frequency generator for outputting a signal at second frequency f₂ which satisfies a relationship of f₂>f₀ with the desired frequency f₀; and
a frequency discriminator for frequency combining a signal generated from said first frequency generator with a signal generated from said second frequency generator to generate a signal containing a component at the desired frequency f₀, and passing therethrough only a frequency region lower than a predetermined threshold frequency of the generated signal,
wherein the signal at the second frequency f₂ generated by said second frequency generator has a frequency variable width of Δf₂, and a relationship of f₁/n>Δf₂/2 is established between frequency f₁/n of the signal generated by said first frequency divider and frequency variable width Δf₂ of said second frequency generator.

2. The frequency synthesizer according to claim 1, further comprising:
a selector applied with the signal at the first frequency f₁ generated by said first frequency generator and applied with a signal at frequency f₁/n generated by said first frequency divider to select one of the signal at the first frequency f₁ or the signal at the frequency f₁/n in accordance with a control signal and to supply the selected signal to said frequency discriminator.

3. The frequency synthesizer according to claim 2, wherein said first frequency divider includes a second frequency divider which is applied with the signal at the first frequency f₁ generated by said first frequency generator and has a frequency division ratio of “2,” and a third frequency divider which is applied with the output of said second frequency divider and has a frequency division ratio of “2,” and said first frequency divider sends a signal at frequency f₁/2 output from said second frequency divider and a signal at frequency f₁/4 output from said third frequency divider to said selector as outputs of said first frequency divider.

4. The frequency synthesizer according to claim 2, wherein said first frequency divider includes a second frequency divider which is applied with the signal at first frequency f₁ generated by said first frequency generator and which has a frequency division ratio of “2,” and a fourth frequency divider which is applied with the signal at the first frequency f₁ and has a frequency division ratio of “4,” and said first frequency divider sends a signal at frequency f₁/2 output from said second frequency divider and a signal at frequency f₁/4 output from said fourth frequency divider to said selector as outputs of said first frequency divider.

5. The frequency synthesizer according to claim 2, wherein said first frequency divider includes a frequency divider for frequency dividing one input signal to generate two signals which are out of phase by 90 degrees.

6. The frequency synthesizer according to claim 1, further comprising:
a first element applied with the signal at the first frequency f₁ generated by said first frequency generator to determine whether the signal at the first frequency f₁ is output to said frequency discriminator or stopped in accordance with a control signal,
wherein said first frequency divider determines whether the signal at frequency f₁/n is output or stopped to said frequency discriminator in accordance with the control signal.

7. The frequency synthesizer according to claim 6, wherein said first frequency divider includes a sixth frequency divider applied with the signal at the first frequency f₁ from said first frequency generator and capable of selecting an output state or a stop state at a frequency division ratio of “2” in accordance with the control signal, and a seventh frequency divider applied with a signal at frequency f₁/2 from said sixth frequency divider and capable of selecting an output state or a stop state at a frequency division ratio of “2,” in accordance with the control signal, and said first frequency divider outputs one of a signal at frequency f₁/2 output from said sixth frequency divider or a signal at frequency f₁/4 output from said seventh frequency divider, selected by the control signal, to said frequency discriminator, as outputs of said first divider.

8. The frequency synthesizer according to claim 6, wherein said first frequency divider includes a sixth frequency divider applied with the signal at the first frequency f₁ from said first frequency generator and capable of selecting an output state or a stop state at a frequency division ratio of “2” in accordance with the control signal, and an eighth frequency divider applied with the signal at the first frequency f₁ and capable of selecting an output state or a stop state at a frequency division ratio of “4” in accordance with the control signal, and said first frequency divider outputs one of a signal at frequency f₁/2 output from said sixth frequency divider or a signal at frequency f₁/4 output from said eighth frequency divider, selected by the control signal, to said frequency discriminator, as outputs of said first divider.

9. The frequency synthesizer according to claim 6, wherein said first element is comprises an amplifier.

10. The frequency synthesizer according to claim 6, wherein said first frequency divider includes a frequency divider for dividing one input signal to generate two signals which are out of phase by 90 degrees.

11. The frequency synthesizer according to claim 2, wherein said frequency division ratio n is four at maximum, said first frequency f₁ is a frequency equal to or higher than 4/3 times as high as an upper limit of the desired frequency f₀, and said second frequency f₂ is a frequency within a range of ¾ times to one time as high as the first frequency f₁.

12. The frequency synthesizer according to claim 1, wherein each of said first frequency generator and said second frequency generator generates two signals which are out of phase by 90 degrees from each other.

13. The frequency synthesizer according to claim 12, wherein at least one of said first frequency generator and said second frequency generator comprises two oscillators for generating signals at the same frequency and out of phase with each other by 90 degrees, and said two oscillators generate the two signals which are out of phase by 90 degrees.

14. The frequency synthesizer according to claim 12, wherein at least one of said first frequency generator of and said second frequency generator comprises an oscillator, and a poly-phase filter applied with an output of said oscillator to generate a signal which is out of phase by 90 degrees from the signal output from said oscillator, and the signal from said oscillator and the signal from said poly-phase filter are output as the two signals which are out of phase by 90 degrees.

15. The frequency synthesizer according to claim 12, wherein at least one of said first frequency generator and said second frequency generator comprises an oscillator for generating a signal at a frequency twice as high as a frequency to be output, and a ninth frequency divider for frequency dividing the signal generated by said oscillator at a frequency division ratio “2” to generate the two signals which are out of phase by 90 degrees.

16. The frequency synthesizer according to claim 1, wherein said frequency discriminator comprises a first combiner for frequency combining the signal generated by said first frequency generator with the signal generated at the second frequency generator to generate a signal which includes a component at the desired frequency f₀, and a second element applied with the output of said first combiner to pass therethrough only a frequency region lower than a predetermined threshold frequency of the input signal.

17. The frequency synthesizer according to claim 16, wherein said second element is comprises a low pass filter.

18. The frequency synthesizer according to claim 16, wherein said second element is comprises an amplifier having low-pass frequency characteristics.

19. The frequency synthesizer according to claim 16, wherein said first combiner is comprises an image rejection mixer.

20. The frequency synthesizer according to claim 1, wherein said frequency discriminator is comprises a second combiner for frequency combining the signal generated by said first frequency generator with the signal generated by said second frequency generator to generate a signal containing a component at the desired frequency f₀, and the frequency characteristics of said second combiner are low-pass characteristic.

21. The frequency synthesizer according to claim 20, wherein said second combiner comprises an image rejection mixer.

22. The frequency synthesizer according to claim 6, wherein said frequency division ratio n is four at maximum, said first frequency f₁ is a frequency equal to or higher than 4/3 times as high as an upper limit of the desired frequency f₀, and said second frequency f₂ is a frequency within a range of ¾ times to one time as high as the first frequency f₁.
